(19) United States
(12) Patent Application Publication
(10) Pub. No.: US 2026/0112809 A1
(43) Pub. Date: Apr. 23, 2026

(54) Multi-Band Base Station Antenna Using Patterned Layer

(71) Applicant: ACE TECHNOLOGIES CORPORATION, Incheon (KR)

(72) Inventors: Ho Yong KIM, Incheon (KR); Tae Kwan LIM, Incheon (KR); Yeon Mun KIM, Gyeonggi-do (KR); Min Seok JUNG, Incheon (KR); Nyambayar Jargalsaikhan, Incheon (KR); Seung Chul LEE, Incheon (KR)

(21) Appl. No.: 18/966,120

(22) Filed: Dec. 2, 2024

(30) Foreign Application Priority Data
Oct. 18, 2024 (KR) 10-2024-0142802

(51) Int. Cl. H01Q 1/36; H01Q 1/42; H01Q 5/30

(52) U.S. Cl. CPC H01Q 1/36; H01Q 1/42; H01Q 5/30

(57) ABSTRACT

The present disclosure relates to a multi-band base station antenna using a patterned layer. According to an aspect of the present disclosure, a multi-band base station antenna using a patterned layer includes a plurality of high band radiating elements, a plurality of low band radiating elements, a first radome which encloses the plurality of high band radiating elements, a second radome which encloses the plurality of low band radiating elements, and a patterned layer inserted into the first radome, the second radome is located above the first radome, and the patterned layer passes a signal which is emitted from the plurality of high band radiating elements and reflects a signal which is emitted from the plurality of low band radiating elements.

### CROSS-REFERENCE TO RELATED APPLICATION

This present application claims the benefit of priority to Korean Patent Application No. 10-2024-0142802, filed on Oct. 18, 2024, in the Korean Intellectual Property Office, the entire disclosure of which is incorporated herein by reference.

### FIELD

The present disclosure relates to a multi-band base station antenna using a patterned layer, and more particularly, to a multi-band base station antenna using a patterned layer in which a selective shielding patterned layer is inserted into a radome.

### BACKGROUND

In accordance with the increase of a high quality video viewing time, traffic rapidly increases so that the need for broadband frequency bands expands. Further, antipathy against electromagnetic devices makes it difficult to install a plurality of antennas in a local area, and in many cases, 5G MMU is installed at LTE installation sites, which increases installation and operation costs. Furthermore, commercialization of wireless communication in 28 GHz bands has been abandoned. Therefore, installation of 5G antennas has been essential to addressing rapid increase in traffic which requires high frequency bands.

In order to overcome these problems, in Korean Registered Patent Publication No. 10-2021-0180595 which is a related art, a multi-band base station antenna 100 which introduces a selective shielding surface to pass signals emitted from a high band radiator and block signals emitted from the low band radiator, between the high band radiator and a low band radiator has been disclosed. According to the related art, in Korean Registered Patent Publication No. 10-2021-0180595, the selective shielding surface was introduced to efficiently suppress interference between high band and low band radiators. However, referring to FIG. 1 which is a cross-sectional view of the related art, there is a problem in that a printed circuit board (PCB) type selective shielding surface 150 and three fixing components for fixing it, including an injection molded product 160, a fiberglass reinforced plastic (FRP) 170, and a snap-rivet 180 are essentially requested.

### SUMMARY

The present disclosure was created to solve the problems as described above and an object of the present disclosure is to provide a multi-band base station antenna using a patterned layer with a reduced production cost.

Another object of the present disclosure is to provide a multi-band base station antenna using a patterned layer with a reduced weight.

Still another object of the present disclosure is to provide a multi-band base station antenna using a patterned layer with improved beam efficiency.

Objects of the present disclosure are not limited to the above-mentioned object, and other objects and advantages of the present disclosure, which are not mentioned, will be understood through the following description, and will become apparent from embodiments of the present disclosure. It is also to be understood that the objects and advantages of the present disclosure may be realized by means and combinations thereof set forth in claims.

In order to achieve the above-described object, according to an aspect of the present disclosure, a multi-band base station antenna using a patterned layer includes a plurality of high band radiating elements; a plurality of low band radiating elements; a first radome which encloses the plurality of high band radiating elements; a second radome which encloses the plurality of low band radiating elements; and a patterned layer inserted into the first radome, in which the second radome is located above the first radome and the patterned layer passes a signal which is emitted from the plurality of high band radiating elements and reflects a signal which is emitted from the plurality of low band radiating elements.

The patterned layer may have a structure in which unit cells are repeatedly disposed.

The unit cell may include a plurality of sub cells and the plurality of sub cells included in the one unit cell has a symmetric relationship to each other or has the same shape.

Each of the plurality of sub cells may include a plurality of metal lines and a metal line of a specific sub cell is connected to a metal line of another adjacent sub cell.

The number of metal lines of each of the plurality of sub cells may correspond to the number of vertices of a polygon corresponding to the shape of the sub cell.

According to another aspect of the present disclosure, a multi-band base station antenna using a patterned layer includes a radome; and a patterned layer inserted into the radome.

The patterned layer may pass a high band incident wave and reflects a low band incident wave.

According to the present disclosure, a patterned layer which passes a high frequency radiation signal and reflects a low frequency radiation signal is inserted into a radome. By doing this, inexpensive material can be used, and the number of components is reduced to lower a production cost.

Further, according to the present disclosure, a light-weight material can be used and the number of components is reduced to lower a weight.

Furthermore, according to the present disclosure, a material having a high permittivity can be used and the number of components is reduced to reduce a dielectric loss, thereby improving a beam efficiency.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a view illustrating a cross-sectional view of a multi-band antenna using a selective shielding surface of the related art;

FIG. 2 is a view illustrating a cross-sectional view of a multi-band base station antenna using a patterned layer according to an exemplary embodiment of the present disclosure;

FIG. 3 is a view illustrating a perspective view of a multi-band base station antenna using a patterned layer according to an exemplary embodiment of the present disclosure;

FIG. 4 is a view illustrating a cross-sectional enlarged view of a radome into which a patterned layer according to an exemplary embodiment of the present disclosure is inserted;

FIG. 5 is a view illustrating a perspective view of a multi-band antenna using a selective shielding surface of the related art;

FIG. 6 is a view illustrating a pattern of a layer according to an exemplary embodiment of the present disclosure;

FIG. 7 is a view for explaining a size constraint of a unit cell which configures a patterned layer according to an exemplary embodiment of the present disclosure;

FIG. 8 is a view illustrating a pattern of a layer according to another exemplary embodiment of the present disclosure;

FIG. 9 is a view illustrating a pattern of a layer according to another exemplary embodiment of the present disclosure;

FIG. 10 is a view illustrating a pattern of a layer according to still another exemplary embodiment of the present disclosure;

FIG. 11 is a view illustrating a high band electric field distribution by a patterned layer according to an exemplary embodiment of the present disclosure; and

FIG. 12 is a view illustrating a low band electric field distribution by a patterned layer according to an exemplary embodiment of the present disclosure.

### DETAILED DESCRIPTION

Hereinafter, reference will be made in detail to exemplary embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the embodiments of the present disclosure, a detailed description of known functions and configurations incorporated herein will be omitted when it may make the subject matter of the present disclosure rather unclear. Further, the accompanying drawings will be exemplarily given to describe the embodiments of the present disclosure, and should not be construed as being limited to the embodiments set forth herein, and it will be understood that the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

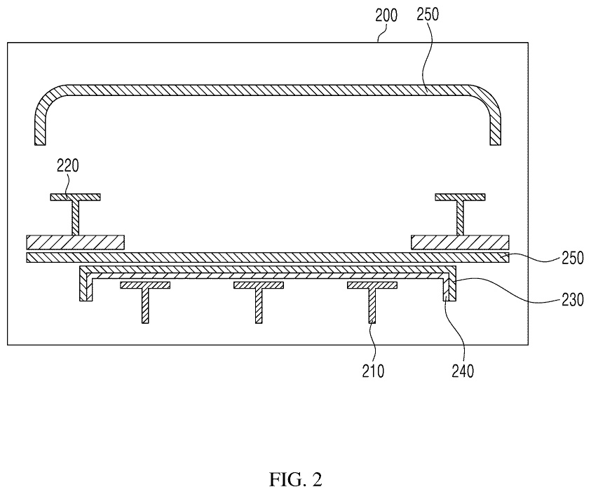

Hereinafter, a multi-band base station antenna using a patterned layer according to the present disclosure will be described in detail with reference to FIGS. 2 to 12.

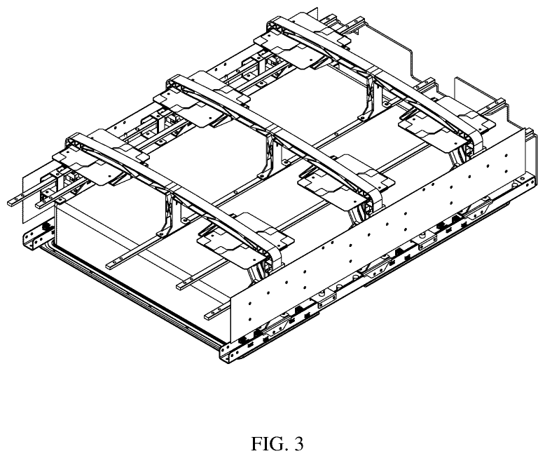

FIG. 2 is a view illustrating a cross-sectional view of a multi-band base station antenna using a patterned layer according to an exemplary embodiment of the present disclosure and FIG. 3 is a view illustrating a perspective view of a multi-band base station antenna using a patterned layer according to an exemplary embodiment of the present disclosure.

Referring to FIGS. 2 and 3, a multi-band base station antenna 200 using a patterned layer according to an exemplary embodiment of the present disclosure includes a plurality of high band radiating elements 210, a plurality of low band radiating elements 220, a first radome 230 which encloses the plurality of high band radiating elements, a patterned layer 240 inserted into the first radome, and a second radome 250 which encloses the plurality of low band radiating elements.

The plurality of high band radiating elements 210 is configured by elements which transmit and receive a high band frequency signal. A frequency band and a physical size of the element are inversely proportional so that the high band radiating element 210 has a smaller size and is designed to have a smaller structure than the low band radiating element 220 located in the same antenna.

Desirably, each of the plurality of high band radiating elements 210 has a balloon structure having a specific balloon and a high impedance element, such as a chalk or a filter, is inserted into the balloon structure to optimize the low band radiating element to have a normal radiation pattern. The plurality of high band radiating elements 210 may be high band radiating elements 210 which are set to radiate a dual polarization signal polarized at +45 degrees and-45 degrees and radiate a band of 1 GHz or higher.

The plurality of low band radiating elements 220 is elements designed to transmit and receive a low frequency band signal. The low frequency signal has a longer wavelength so that the physical size of the element increases in proportion to the frequency band to be transmitted and received. The low band radiating element 220 is designed to be larger than the high band radiating element 210, thereby effectively radiating the low frequency signal.

Desirably, each of the plurality of low band radiating elements 220 has a dipole structure and an element having a high impedance, such as a choke or a filter, is inserted to block the current induced by coupling. Further, the plurality of low band radiating elements 220 may be radiators which are set to radiate a dual polarization signal polarized at +45 degrees and −45 degrees and radiate a band of 1 GHz or lower.

The radomes 230 and 250 are structures which protect the antenna from the external environment and minimize the influence on the antenna performance. The radome is manufactured with a material transparent to radio waves, which allows electromagnetic waves transmitted and received by the antenna to pass through without loss. According to the exemplary embodiment of the present disclosure, the radomes are configured by a first radome 230 which encloses the high band radiating element 210 and a second radome 250 which encloses the low band radiating element 220.

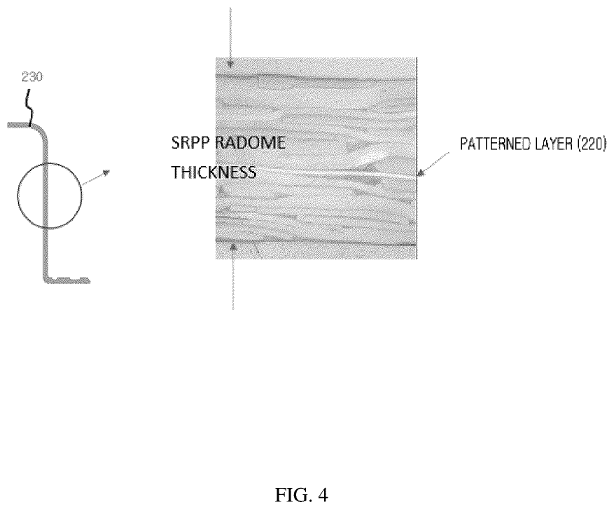

The patterned layer 240 is inserted into the first radome which encloses the high band radiating element to function to selectively pass or shield an RF signal according to a frequency. FIG. 4 is a view enlarging a cross-sectional view of the first radome 230 and a patterned layer 240 is inserted into a center portion of the first radome 230. Specifically, the patterned layer 240 may operate to pass a signal of a predetermined frequency band and shield a frequency signal of a frequency band other than the corresponding frequency band. Desirably, the patterned layer may operate to pass a signal radiated from the high band radiating element 210, desirably, a band of approximately 3.4 GHz to 3.8 GHz and shield a signal radiated from the low band radiating element 220, desirably, a band of approximately 1 GHz or lower.

Specifically, the patterned layer 240 operates to shield the signal from the low band radiating element 220 so that the patterned layer may serve as a reflector, from the viewpoint of the low band radiating element 220.

When the high band radiating element 210 and the low band radiating element 220 are located to be adjacent to each other, the signal of the low band radiating element 220 is induced to the high band radiating element 210 to frequently affect the signal of the high band radiating element 210. Further, it is important for the multi-band antenna to ensure isolation between the high band radiating element 210 and the low band radiating element 220.

Accordingly, the patterned layer 240 is inserted into the first radome 230 which encloses the high band radiating element 210 and the low band radiating element 220 is located above the first radome 230 to block the signal of the low band radiating element 220 from being induced to the high hand radiating element 210. By doing this, an isolation characteristic better than the multi-band antenna of the related art can be provided and the radiation pattern of the high band radiating element 210 is not affected by the patterned layer 240.

The patterned layer 240 may be configured in various ways. For example, the patterned layer may be formed by a film, a pressed metal line, an etched PCB, etc. so that various processes and materials in accordance with the application fields may be selected. The patterned layer 240 may be designed to optimize a performance in a desired frequency band.

Specifically, the patterned layer 240 implemented as a pressed metal line or an etched PCB provides a durability robust to the high temperature and the external environment and the pattern is more precisely formed to increase the accuracy of the signal processing.

The patterned layer 240 implemented as a film may be manufactured with a material of polyphenylene oxide (PPO) and this material provides excellent dielectric characteristics and a low loss factor. The permittivity of polyphenylene oxide has a range of approximately 2.8 and 3.2 and desirably, is set to approximately 2.8 to 2.9 to minimize the dielectric loss generated in the high frequency band. Specifically, an extinction coefficient of polyphenylene oxide is in the range of approximately 0.003 and 0.005 at a frequency of 24 GHz and desirably, approximately 0.0044 to 0.0048, so that energy loss at the high frequency is very small. With this characteristic, the patterned layer 240 may optimize the antenna performance and specifically, effects of increasing the efficiency of beam and improving signal transmission may be expected. The polyphenylene oxide material has excellent durability and high thermal stability so that the performance of the film may be maintained even in the change of the external environment.

Further, the patterned layer 240 implemented as a film may be inserted by a sol-gel method. Specifically, the sol-gel method is a method of forming a film by forming sol obtained by dissolving polymers and metal oxides, and then converting sol into a gel state. According to the sol-gel method, when the patterned layer 240 is inserted into the first radome 230, a uniform thickness and a precise pattern of the patterned layer 240 can be formed to optimize the high frequency characteristic. The sol-gel method is performed at a relatively low temperature so that the thermal damage on the material of the radome 230 may be reduced as compared with the high temperature process of the related art, which improves the durability of the entire antenna device. This method enables mass production at a low cost to be economically efficient. The property of the patterned layer 240 is finely adjusted during the process to provide an optimal characteristic in accordance with various frequency bands.

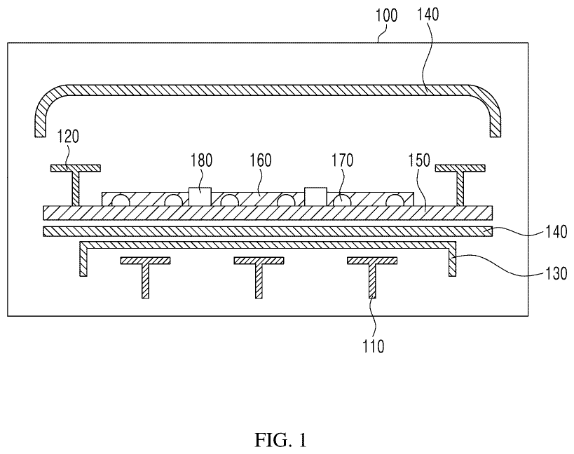

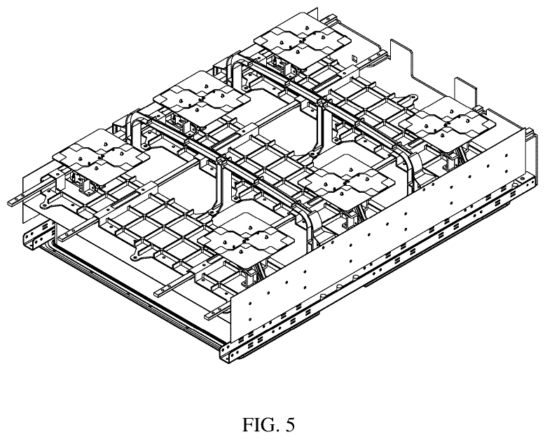

FIG. 5 is a view illustrating a perspective view of a multi-band antenna of the related art. Referring to FIGS. 1 and 2 together, the multi-band antenna 100 using a selective shielding surface of the related art shows a complex structure more than FIG. 3 which is a perspective view of the present disclosure in which the selective shielding surface 150 is replaced with a patterned layer 240 to be inserted into the first radome 230, due to the selective shielding surface 150 formed with PCB and the fixing components for fixing it, such as the injection molded product 160, the FRP 170, and the snap-rivet 180. According to the present disclosure, the patterned layer 240 is inserted into the first radome 230 to provide the same performance without the complex fixing components. By doing this, the antenna structure is simplified to drastically reduce the number of components and the production process is also simplified to expect the effect of reducing the manufacturing cost. Further, the selective shielding surface 150 of the related art had limitations in physical size and weight, but the patterned layer 240 of the present disclosure uses a light-weight material to optimize an electric wave blocking and passing function while reducing the weight of the entire antenna.

The pattern of the patterned layer 240 has a structure in which unit cells are repeatedly disposed. One unit cell of the patterned layer 240 includes a plurality of sub cells and the plurality of sub cells included in one unit cell has the symmetrical relationship or the same shape. Each of the plurality of sub cells includes a plurality of metal lines and a metal line of a specific sub cell is connected to a metal line of another adjacent sub cell. At this time, the number of metal lines of each of the plurality of sub cells corresponds to the number of vertices of a polygon corresponding to the shape of the sub cell.

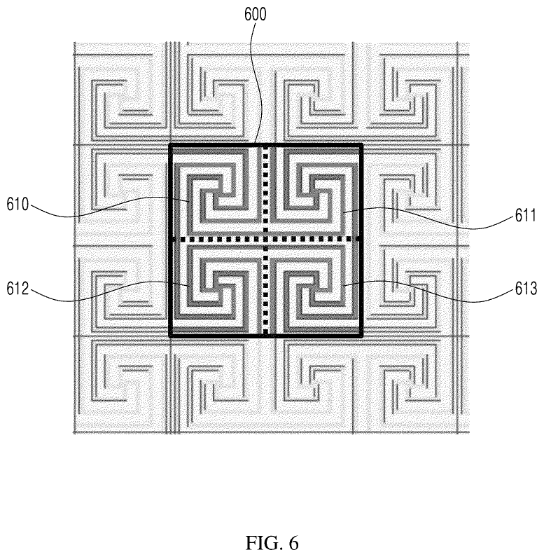

The pattern of the patterned layer 240 according to the exemplary embodiment of the present disclosure illustrated in FIG. 6 has a structure in which square unit cells 600 are repeated. One unit cell 600 has a total of four square sub cells including a first sub cell 610, a second sub cell 611, a third sub cell 612, and a fourth sub cell 613 and the sub cells have a mirror-symmetric relationship with each other. Each metal line of each sub cell is connected to a metal line of another adjacent sub cell starting from the center of the sub cell and the number of metal lines of each sub cell is four.

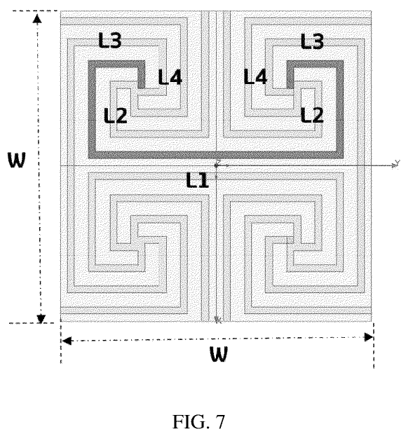

Further, referring to FIG. 7, a width W of the unit cell of the patterned layer 240 illustrated in FIG. 6 is set to 0.132λ with respect to a center frequency of an operation band. A total length (L1+L2×2+L3×2+L4×2) of the connected metal lines of the patterned layer 240 is set to 0.25λ with respect to a center frequency of an operation band, a width of the metal line is set to 0.002λ to 0.004λ with respect to the center frequency of the operation band, and an interval between the metal lines is set to 0.002λ to 0.006λ with respect to the center frequency of the operation band.

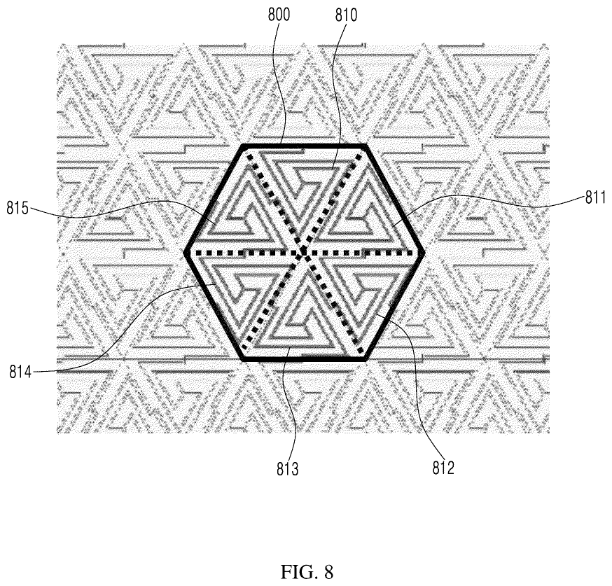

A pattern of the patterned layer 240 according to another exemplary embodiment of the present disclosure illustrated in FIG. 8 has a structure in which hexagonal unit cells 800 are repeatedly disposed. One unit cell 800 of the patterned layer 240 is formed of a total of six triangular sub cells including a first sub cell 810, a second sub cell 811, a third sub cell 812, a fourth sub cell 813, a fifth sub cell 814, and a sixth sub cell 815 and each sub cell has the same shape. Each metal line of each sub cell of the patterned layer 240 meets a metal line of another adjacent sub cell at a center of a side starting from the center of each sub cell. The number of metal lines of each sub cell of the patterned layer 240 is three.

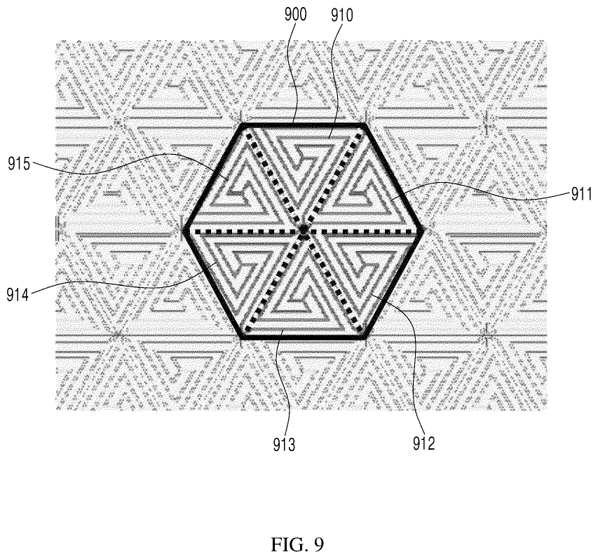

A pattern of the patterned layer 240 according to another exemplary embodiment of the present disclosure illustrated in FIG. 9 has a structure in which hexagonal unit cells 900 are repeatedly disposed. One unit cell 900 of the patterned layer 240 is formed of a total of six triangular sub cells including a first sub cell 910, a second sub cell 911, a third sub cell 912, a fourth sub cell 913, a fifth sub cell 914, and a sixth sub cell 915 and each sub cell has the same shape. Each metal line of each sub cell of the patterned layer 240 meets a metal line of another adjacent sub cell at a vertex starting from the center of each sub cell. The number of metal lines of each sub cell of the patterned layer 240 is three.

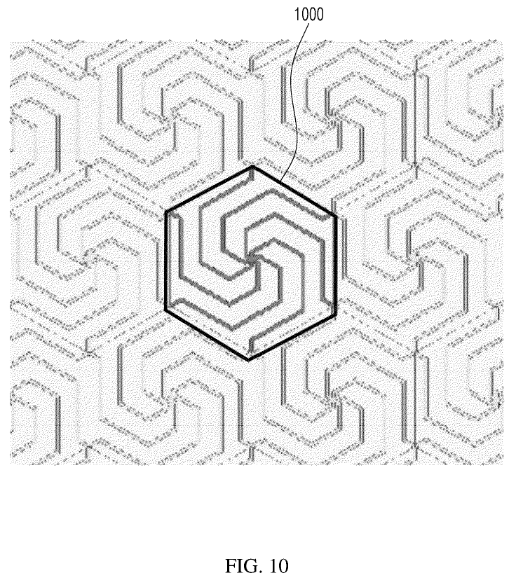

A pattern of the patterned layer 240 according to still another exemplary embodiment of the present disclosure illustrated in FIG. 10 has a structure in which hexagonal unit cells 1000 are repeatedly disposed. One unit cell 1000 of the patterned layer 240 is formed of one hexagonal sub cell. The metal line meets a metal line of another adjacent sub cell at a vertex starting from the center of a sub cell. The number of metal lines of the sub cell of the patterned layer 240 is six.

The basic electrical characteristics of the patterned layer 240 operate in a wide band and have vertical, horizontal, ±45 and circular current distributions. By doing this, the patterned layer 240 has a basic characteristic of operating in various polarizations.

Further, it is polarized at ±45° as seen from the front of the multi-band base station antenna 200, but it is changed to a vertical polarized component as an incident angle varies. Therefore, in order to allow the patterned layer 240 to operate at a wide angle, the patterned layer needs to operate for the changed polarized shape and various shapes.

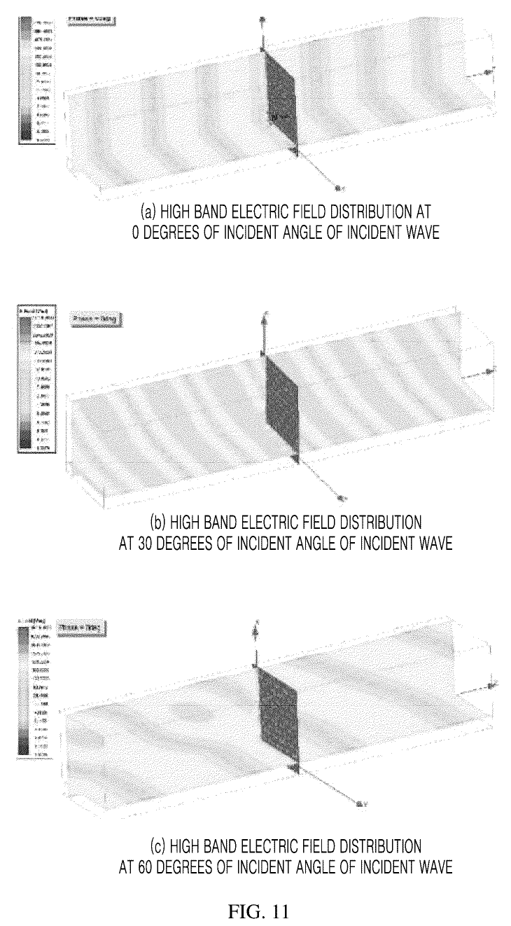

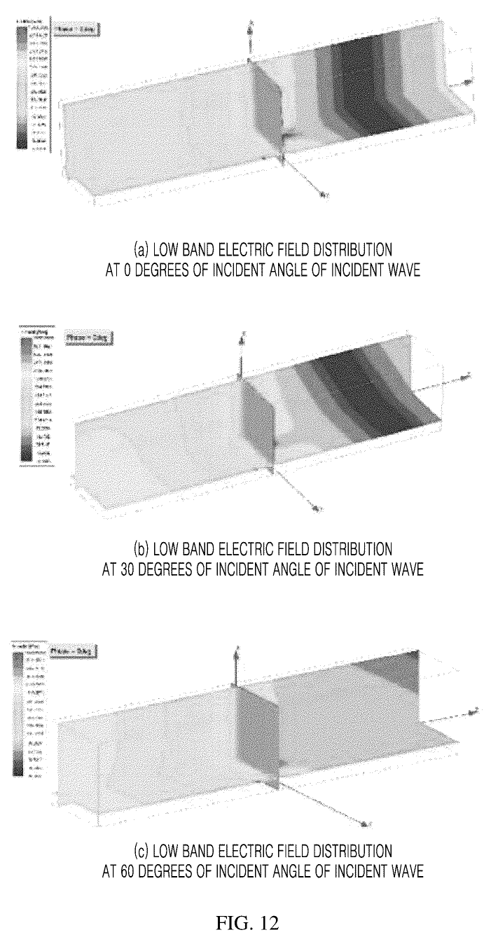

FIG. 11 is a view illustrating an electric field distribution which passes through a patterned layer 240 when an incident wave is a high band according to an incident angle of an incident wave. FIG. 12 is a view illustrating an electric field distribution which passes through a patterned layer 240 when an incident wave is a low band according to an incident angle of an incident wave. Referring to FIG. 11, it is understood that the patterned layer passes an incident wave of 0 degrees (a), 30 degrees (b), and 60 degrees (c) in a high band and referring to FIG. 12, it is understood that the patterned layer blocks an incident wave of 0 degrees (a), 30 degrees (b), and 60 degrees (c) in a low band. According to the present disclosure, even though a beam direction is changed from −60 degrees to +60 degrees in a horizontal direction, the operation may be performed without causing the distortion of the beam pattern.

The present disclosure is applicable to not only a 5G communication system, but also a future communication system which uses various frequency bands. Specifically, the present disclosure plays an important role in communication infrastructures which requires a convergent antenna which utilizes both the high frequency band and the low frequency band. Further, the technology of the patterned layer 240 of the present disclosure is applicable to various application fields, such as other wireless communication equipment, vehicle communication, and IoT devices and contributes to building a high performance communication environment of the future. The design and the material of the layer can be customized according to the frequency band, providing scalability for optimization to specific application fields.

In the specification (particularly, in the claims) of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

1. A multi-band base station antenna using a patterned layer, comprising:
a plurality of high band radiating elements;
a plurality of low band radiating elements;
a first radome which encloses the plurality of high band radiating elements;
a second radome which encloses the plurality of low band radiating elements; and
a patterned layer inserted into the first radome,
wherein the second radome is located above the first radome and the patterned layer passes a signal which is emitted from the plurality of high band radiating elements and reflects a signal which is emitted from the plurality of low band radiating elements.

2. The multi-band base station antenna using a patterned layer according to claim 1, wherein the patterned layer has a structure in which unit cells are repeatedly disposed.

3. The multi-band base station antenna using a patterned layer according to claim 2, wherein the unit cell includes a plurality of sub cells and the plurality of sub cells included in the one unit cell has a symmetric relationship to each other or has the same shape.

4. The multi-band base station antenna using a patterned layer according to claim 3, wherein each of the plurality of sub cells includes a plurality of metal lines and a metal line of a specific sub cell is connected to a metal line of another adjacent sub cell.

5. The multi-band base station antenna using a patterned layer according to claim 4, wherein the number of metal lines of each of the plurality of sub cells corresponds to the number of vertices of a polygon corresponding to the shape of the sub cell.

6. The multi-band base station antenna using a patterned layer according to claim 1, wherein the patterned layer is implemented as a film.

7. The multi-band base station antenna using a patterned layer according to claim 6, wherein the film is formed of a polyphenylene oxide material.

8. The multi-band base station antenna using a patterned layer according to claim 7, wherein a permittivity of the polyphenylene oxide material is in a range of 2.8 to 3.2.

9. The multi-band base station antenna using a patterned layer according to claim 7, wherein an extinction coefficient of the polyphenylene oxide material is in a range of 0.003 to 0.005 at 24 GHz.

10. The multi-band base station antenna using a patterned layer according to claim 6, wherein the film is inserted into the first radome by a sol-gel method.

11. A multi-band base station antenna using a patterned layer, comprising:
a radome; and
a patterned layer inserted into the radome.

12. The multi-band base station antenna using a patterned layer according to claim 11, wherein the patterned layer passes a high band incident wave and reflects a low band incident wave.

13. The multi-band base station antenna using a patterned layer according to claim 11, wherein the patterned layer has a structure in which unit cells are repeatedly disposed.

14. The multi-band base station antenna using a patterned layer according to claim 13, wherein the unit cell includes a plurality of sub cells and the plurality of sub cells included in the one unit cell has a symmetric relationship to each other or has the same shape.

15. The multi-band base station antenna using a patterned layer according to claim 14, wherein each of the plurality of sub cells includes a plurality of metal lines and a metal line of a specific sub cell is connected to a metal line of another adjacent sub cell.

16. The multi-band base station antenna using a patterned layer according to claim 15, wherein the number of metal lines of each of the plurality of sub cells corresponds to the number of vertices of a polygon corresponding to the shape of the sub cell.

17. The multi-band base station antenna using a patterned layer according to claim 11, wherein the patterned layer is implemented as a film.

18. The multi-band base station antenna using a patterned layer according to claim 17, wherein the film is formed of a polyphenylene oxide material.

19. The multi-band base station antenna using a patterned layer according to claim 18, wherein a permittivity of the polyphenylene oxide material is in a range of 2.8 to 3.2.

20. The multi-band base station antenna using a patterned layer according to claim 18, wherein an extinction coefficient of the polyphenylene oxide material is in a range of 0.003 to 0.005 at 24 GHz.

21. The multi-band base station antenna using a patterned layer according to claim 17, wherein the film is inserted into the radome by a sol-gel method.
